(19) United States
(12) Patent Application Publication
(10) Pub. No.: US 2026/0126977 A1
(43) Pub. Date: May 7, 2026

(54) STATIC PROFILING WITH GRAPH NEURAL NETWORKS

(71) Applicant: Oracle International Corporation, Redwood Shores, CA (US)

(72) Inventors: Vojin JOVANOVIC, Zurich (CH); Milan CUGUROVIC, Zurich (CH); Lazar MILIKIC, Zurich (CH)

(73) Assignee: Oracle International Corporation, Redwood Shores, CA (US)

(21) Appl. No.: 18/935,354

(22) Filed: Nov. 1, 2024

(51) Int. Cl. G06F 8/41; G06N 3/042; G06N 3/0499

(52) U.S. Cl. CPC G06F 8/433; G06F 8/4443; G06N 3/042; G06N 3/0499

(57) ABSTRACT

A method implements static profiling with graph neural networks. The method includes executing a block model with a control flow graph to generate a block vector corresponding to a block of the control flow graph of source code. The method further includes executing a graph neural network model with the control flow graph and the block vector to generate a graph vector. The method further includes executing a feed-forward neural network with the graph vector to generate a branch-frequency prediction. The method further includes incorporating the branch-frequency prediction into a code profile.

### BACKGROUND

Collecting accurate program profiles aids in optimizing program performance, as profile-guided optimization (PGO) leverages profiles to tailor compilation to runtime behavior. Compilers utilizing dynamic profiling, where profiles are collected by executing programs with representative inputs, may achieve performance gains that reduce runtimes of compiled code.

Despite benefits from profile-guided optimization, complexity and resource demands of collecting dynamic profiles limit widespread adoption. Identifying representative inputs that reflect application use cases accurately is challenging, and collecting profiles based on inputs requires two compilations and a profile-collection run. As a result, large-scale software systems may not use profile-guided optimization in production due to difficulties obtaining program profiles.

Static profiling techniques are an alternative to dynamic profiling challenges and may allow program profile prediction without runtime profiling and repeated compilation overhead. Static profiling methods may rely on heuristic-based approaches or machine learning (ML) models. Heuristic models, though efficient, depend on compiler-developer intuition and often fail to cover corner cases. Machine learning based models may capture complex program patterns and outperform heuristic models by delivering higher-quality profiles.

Challenges with machine learning based static profilers include the inability to directly process and exploit an intermediate representation (IR) structure from a compiler and the inability to use calling context information effectively. For example, machine learning models may rely on handcrafted features to capture structural data from the intermediate representation of a program, which restricts the ability to fully represent the complexity of the intermediate representation. Additionally, machine learning models may make predictions based on individual function information while neglecting broader calling context.

### SUMMARY

In general, in one or more aspects, the disclosure relates to a method implementing static profiling with graph neural networks. The method includes executing a block model with a control flow graph to generate a block vector corresponding to a block of the control flow graph of source code. The method further includes executing a graph neural network model with the control flow graph and the block vector to generate a graph vector. The method further includes executing a feed-forward neural network with the graph vector to generate a branch-frequency prediction. The method further includes incorporating the branch-frequency prediction into a code profile.

In general, in one or more aspects, the disclosure relates to a system that includes at least one processor and an application that executes on the at least one processor. Executing the application performs executing a block model with a control flow graph to generate a block vector corresponding to a block of the control flow graph of source code. Executing the application further performs executing a graph neural network model with the control flow graph and the block vector to generate a graph vector. Executing the application further performs executing a feed-forward neural network with the graph vector to generate a branch-frequency prediction. Executing the application further performs incorporating the branch-frequency prediction into a code profile.

In general, in one or more aspects, the disclosure relates to a non-transitory computer readable medium including instructions executable by at least one processor. Executing the instructions performs executing a block model with a control flow graph to generate a block vector corresponding to a block of the control flow graph of source code. Executing the instructions further performs executing a graph neural network model with the control flow graph and the block vector to generate a graph vector. Executing the instructions further performs executing a feed-forward neural network with the graph vector to generate a branch-frequency prediction. Executing the instructions further performs incorporating the branch-frequency prediction into a code profile.

Other aspects of one or more embodiments may be apparent from the following description and the appended claims.

### BRIEF DESCRIPTION OF DRAWINGS

FIG. 1 and FIG. 2 show diagrams in accordance with the disclosure.

FIG. 3 shows a method in accordance with the disclosure.

FIG. 4, FIG. 5, FIG. 6, and FIG. 7 show examples in accordance with the disclosure.

FIG. 8A and FIG. 8B show computing systems in accordance with the disclosure.

Similar elements in the various figures are denoted by similar names and reference numerals. The features and elements described in one figure may extend to similarly named features and elements in different figures.

### DETAILED DESCRIPTION

One or more embodiments may address the challenges of machine learning based static profiles using a graph neural network (GNN)-based static profiling solution that directly exploits structural information from control flow graphs (CFGs) while enabling context-sensitive profile predictions. Instead of relying on manually engineered structural features, embodiments of the disclosure may capture structural information directly from a control flow graph. By working on a graph structure, disclosed machine learning models learn relationships between blocks of the control flow graph, resulting in more accurate and efficient profile predictions.

Additionally, static profiling may be extended by predicting context-sensitive profiles, which may be performed after generating context-insensitive profiles. Context-insensitive profiles may be inferred during parsing. The context-insensitive profiles may be refined to form context-sensitive profiles by combining a caller control flow graph with a callee control flow graph. The combining process creates a unified graph integrating contextual information, enabling the prediction of more accurate profiles by considering broader execution context in which each method being compiled is invoked.

The disclosure presents an end-to-end graph neural network based static profiling framework that leverages structural information from control flow graphs (CFGs), addressing limitations of traditional static profilers. Embodiments of the disclosure may be applicable within a compiler that may operate on a control flow graph and perform ahead-of-time (AOT) compilation. For example, the compiler may be native image compiler (e.g., the Oracle® GraalVM® native image compiler) that compiles code (e.g., Java® code) ahead-of-time (AOT) into a standalone native executable instead of relying on a virtual machine at runtime, with the resulting binary executable directly by an operating system. Oracle® and GraalVM® are registered trademarks Oracle International Corporation, 500 Oracle Parkway, Redwood City, California, United States 94065. Java® is a registered trademark of Oracle America, Inc., 500 Oracle Parkway, Redwood City, California, United States 94065.

Embodiments of the disclosure may reduce reliance on manually engineered features by enabling a machine learning model to directly capture structural dependencies from control flow graphs, lowering feature engineering effort while improving representation of complex control flow relationships. Profiling accuracy may increase by introducing context-insensitive and context-sensitive predictions enabling the capture of broader execution contexts and improve static profiling accuracy. A geometric mean runtime speedup on various programs, including industry-standard benchmarks may be realized.

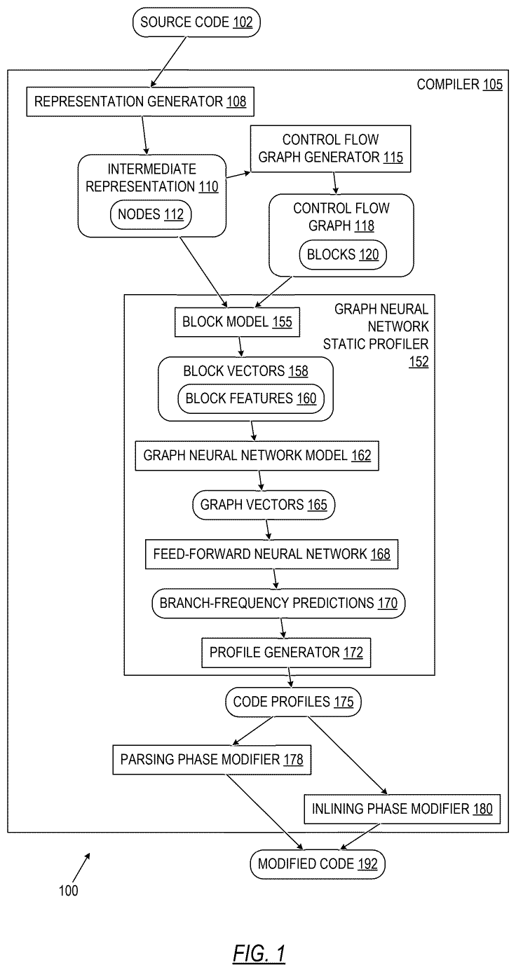

Turning to FIG. 1, the system (100) may address the challenges of machine learning based static profiles using a graph neural network (GNN)-based static profiling solution that may include context-sensitive profile predictions. The system (100) is a computing system that includes multiple hardware and software components. The hardware and software components include memory, at least one processor, data, and instructions that operate to generate the modified code (192) from the source code (102). Each element of the system (100) may include software components with data and instructions and may include hardware components with memory and processors. Although shown as monolithic, the system (100) may be distributed with the hardware and software components operating on multiple computing systems.

The source code (102) includes program instructions written in a high-level programming language (Java, C, C++, python, etc.). The source code (102) defines multiple programs or methods to be compiled. The source code (102) may be input to the compiler (105) for processing and optimization.

The compiler (105) translates and optimizes the source code (102) to generate the modified code (192). The compiler (105) may include the graph network static profiler (152) to predict profiles and enable the performance of profile-guided optimizations during compilation. The compiler (105) may execute multiple phases, including parsing and inlining phases, to process the source code (102).

The representation generator (108) converts the source code (102) into the intermediate representation (110). The representation generator (108) may parse the source code (102) and create data structures representing the program semantics in a form suitable for further analysis and transformation by the compiler (105).

The intermediate representation (110) provides an internal compiler representation of the source code (102). The intermediate representation (110) may correspond to one of the programs defined in the source code (102). The intermediate representation (110) includes the nodes (112) corresponding to program instructions and control flow and includes edges that connect the program instructions. The edges of the intermediate representation (110) may be data flow edges or control flow edges. Data flow edges indicate the flow of data between the nodes (112) and control flow edges indicate the possible flow of control between the nodes (112). The intermediate representation (110) may be input to both the control flow graph generator (115) and the block model (155) for further processing.

The nodes (112) represent individual instructions or operations from the source code (102) within the intermediate representation (110). One of the nodes (112) may correspond to one of the instructions in the source code (102). The nodes (112) encode semantics of the original source code (102) in a format amenable to compiler analysis and transformation. As an example, one of the nodes (112) may represent conditional branching logic (e.g., an if statement). The conditional branching logic may be an if statement with an input edge that identifies a Boolean condition to be evaluated, a true successor edge that points to a node to execute when the condition is true, and a false successor edge that points to a node to execute when the condition is false.

The control flow graph generator (115) constructs the control flow graph (118) from the intermediate representation (110). The control flow graph generator (115) analyzes the nodes (112) and corresponding relationships to determine the control flow structure of the program stored in the control flow graph (118).

The control flow graph (118) represents the structure and execution flow of a program defined in the source code (102). The control flow graph (118) contains the blocks (120) connected by edges indicating possible execution paths. The control flow graph (118) may be input to the block model (155) and the graph neural network model (162) of the graph network static profiler (152) for analysis and profile prediction.

The blocks (120) are units within the control flow graph (118). One of the blocks (120) may group together multiple ones of the nodes (112) from the intermediate representation (110). The blocks (120) may include entry and exit points connected by edges to other blocks, forming the structure of the control flow graph (118). The blocks (120) may correspond to basic blocks or larger code segments in the original source code (102).

The graph neural network static profiler (152) processes the control flow graph (118) and the intermediate representation (110) to generate the code profiles (175). The graph neural network static profiler (152) may generate the code profiles (175) without executing the source code (102). The graph neural network static profiler (152) includes the block model (155), the graph neural network model (162), the feed-forward neural network (168), and profile generator (172). The graph neural network static profiler (152) may execute during parsing and inlining phases of compilation to predict branch frequencies and generate profiles for optimizing code.

The block model (155) processes the control flow graph (118) and the intermediate representation (110) to generate the block vectors (158). The block model (155) may analyze individual blocks of the control flow graph (118) and the nodes (112) of the intermediate representation (110) to extract relevant features. The block model (155) may determine if a block corresponds to an if statement from the source code. The block model (155) generates multiple block features for each block from the control flow graph and intermediate representation.

The block vectors (158) are outputs from the block model (155) and inputs to the graph neural network model (162). One of the block vectors (158) may correspond to one of the blocks (120) of the control flow graph (118). The block vectors (158) represent characteristics (node type characteristics, estimated execution characteristics, control flow characteristics, etc.) of individual blocks using the block features (160) extracted by the block model. The block vectors (158) may include aggregated block features generated by the block model.

The block features (160) are components of the block vectors (158). Multiple ones of the block features (160) may form one of the block vectors (158). The block features (160) may include node type features, code characteristic estimation features, and control flow characteristic features extracted from the control flow graph and intermediate representation. The block features (160) characterize aspects of individual blocks such as node types, estimated computational cost, and position within control flow.

The graph neural network model (162) may include a graph neural network (GNN) and processes the block vectors (158) and the control flow graph (118) to generate the graph vectors (165). The graph neural network model (162) aggregates information between neighboring blocks in the control flow graph (118) to generate the graph vectors (165). The graph neural network model (162) may use techniques like graph convolution to capture structural information from the input control flow graph (118). The graph neural network model (162) may (e.g., during an inlining phase) process an inlined control flow graph that combines a caller control flow graph with a callee control flow graph. A caller control flow graph may represent the control flow structure of a method (the caller) that invokes another method (the callee). A callee control flow graph represents the control flow structure of the method being called or invoked (the callee). When inlining is performed, the callee control flow graph may be integrated into the caller control flow graph at the point of invocation of the callee by the caller.

The graph vectors (165) are outputs from the graph neural network model (162) and inputs to the feed-forward neural network (168). One of the graph vectors (165) may represent one of the block vectors (158) and include information from multiple ones of the block vectors (158). The graph vectors (165) include encoded feature representations of blocks that capture the role and position of each block within the control flow graph (118).

The feed-forward neural network (168) processes the graph vectors (165) to generate the branch-frequency predictions (170). The feed-forward neural network (168) may include a neural network with multiple layers, which may include fully connected layers. The feed-forward neural network (168) may process multiple graph vectors corresponding to an if block and its true and false branch blocks to predict the branch frequency for that if statement.

The branch-frequency predictions (170) are outputs from the feed-forward neural network (168) and inputs to the profile generator (172). One of the branch-frequency predictions (170) may correspond to one of the blocks (120) of the control flow graph (118). The branch-frequency predictions (170) may include predicted execution probabilities for true branches of if statements in the control flow graph (118). The branch-frequency predictions (170) may be refined using heuristics such as loop guards and exit guards before being incorporated into the code profiles (175).

The profile generator (172) processes the branch-frequency predictions (170) to generate the code profiles (175). The profile generator (172) may apply heuristics to refine the branch-frequency predictions (170). The profile generator (172) incorporates the refined branch-frequency predictions into context-insensitive profiles during parsing and context-sensitive profiles during inlining. Context-insensitive profiles include execution frequency predictions that are aggregated across possible calling contexts for a method, generated during the parsing phase. Context-sensitive profiles include execution frequency predictions that may include the calling context of a method, generated during the inlining phase by incorporating the caller control flow graph into the callee control flow graph.

The code profiles (175) are outputs from the profile generator (172) and may be inputs to the parsing phase modifier (178) and the inlining phase modifier (180). One of the code profiles (175) may correspond to one of the programs defined within the source code (102). The code profiles (175) may include branch-frequency predictions for if statements in the control flow graph (118). The code profiles (175) may include context-insensitive profiles generated during parsing and context-sensitive profiles generated during inlining. The code profiles (175) may incorporate loop and dead-end heuristics to refine branch-frequency predictions. A loop heuristic (or loop guard) may assign a minimum probability for one of the branch-frequency predictions (170) for branches leading into loop bodies to prioritize loops that may be executed multiple times. A dead-end heuristic (or exit guard) may cap the probabilities of branches leading to program termination, to prevent overestimation of terminating paths to prevent overlooking optimization opportunities in non-terminating branches.

The parsing phase modifier (178), which may be an optimizer of the compiler (105), processes the code profiles (175) to generate at least a portion of the modified code (192). The parsing phase modifier (178) may apply profile-guided optimizations during the parsing phase of compilation based on the context-insensitive profiles in the code profiles (175). The parsing phase modifier (178) may modify the intermediate representation (110) or the control flow graph (118) based on the predicted branch frequencies to improve program performance at runtime.

The inlining phase modifier (180), which may be another optimizer of the compiler (105), processes the code profiles (175) to generate at least a portion of the modified code (192). The inlining phase modifier (180) may apply profile-guided optimizations during the inlining phase of compilation based on the context-sensitive profiles in the code profiles (175). The inlining phase modifier (180) may inline callee methods into caller methods and modify the resulting control flow graph based on the predicted branch frequencies to improve program performance.

The modified code (192) is an output of the compiler (105) that is a modified version of the source code (102) that may be at a lower level (e.g., byte codes, assembly language, binary instructions, etc.). The modified code (192) may be modified to be optimized for reduced size, reduced runtime, etc. The modified code (192) may incorporate profile-guided optimizations based on the code profiles (175) generated by the graph neural network static profiler. The modified code (192) may have improved performance compared to unoptimized code due to branch prediction and inlining decisions informed by the static profiling.

Each of the models utilized by the system (100) may include one or more machine learning models. The machine learning models used by the system (100) may include neural networks and may operate using one or more layers of weights that may be sequentially applied to sets of input data, which may be referred to as input vectors. For each layer of a machine learning model, the weights of the layer may be multiplied by the input vector to generate a collection of products, which may then be summed to generate an output for the layer that may be fed, as input data, to a next layer within the machine learning model. The output of the machine learning model may be the output generated from the last layer within the machine learning model. Multiple machine learning models may operate sequentially or in parallel. The output may be a vector or scalar value. The layers within the machine learning model may be different and correspond to different types of models. As an example, the layers may include layers for recurrent neural networks, convolutional neural networks, transformer models, attention layers, perceptron models, etc. Perceptron models may include one or more fully connected (also referred to as linear) layers that may convert between the different dimensions used by the inputs and the outputs of a model. Different types of machine learning algorithms may be used, including regression, decision trees, random forests, support vector machines, clustering, classifiers, principal component analysis, gradient boosting, etc.

The machine learning models may be trained by inputting training data to a machine learning model to generate training outputs that are compared to expected outputs. For supervised training, the expected outputs may be labels associated with a given input. For unsupervised learning, the expected outputs may be previous outputs from the machine learning model. The difference between the training output and the expected output may be processed with a loss function to identify updates to the weights of the layers of the model. After training on a batch of inputs, the updates identified by the loss function may be applied to the machine learning model to generate a trained machine learning model. Different algorithms may be used to calculate and apply the updates to the machine learning model, including back propagation, gradient descent, etc.

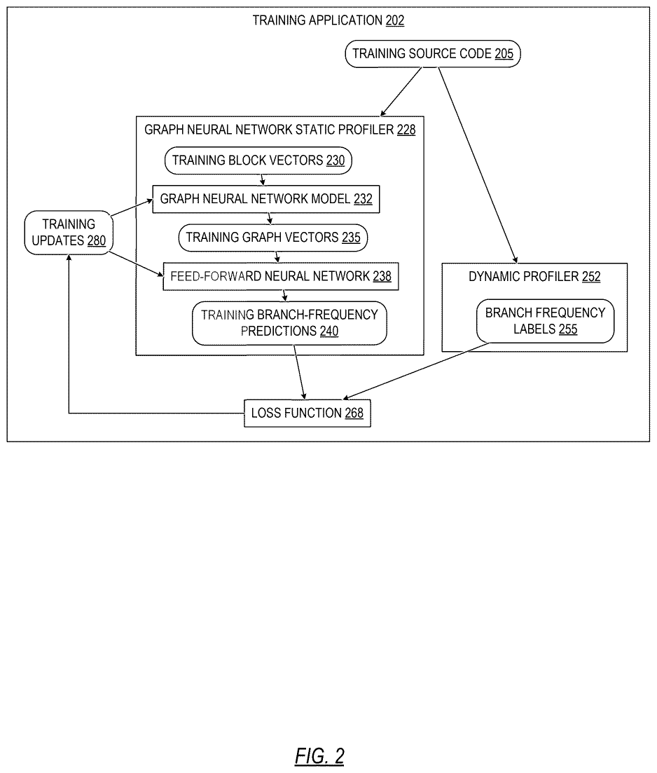

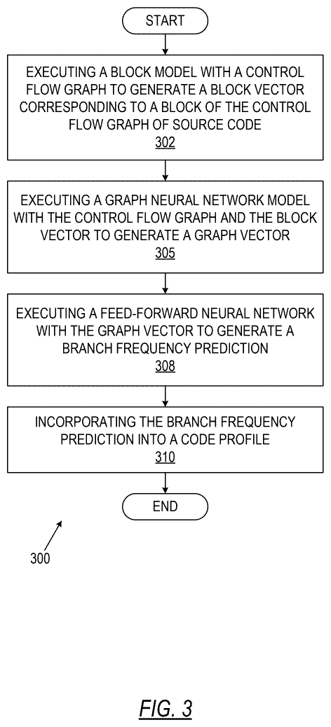

Turning to FIG. 2, the training application (202) includes hardware and software components that execute to train machine learning models. The training application (202) processes training data, including the training source code (205), to optimize parameters of the graph neural network model (232) and the feed-forward neural network (238). The training application (202) may utilize supervised learning techniques with labeled data to improve prediction accuracy of the models (232) and (238).

The training source code (205) includes program instructions used as input during the training process. The training source code (205) may be written in high-level programming languages like Java, C, C++, Python, etc. The training source code (205) provides examples of real-world code structures and patterns for the models to learn from. The training source code (205) may be processed to extract control flow graphs and intermediate representations.

The graph neural network static profiler (228) includes components that may analyze the training source code (205) without executing the training source code (205). The graph neural network static profiler (228) may be a version of the graph neural network static profiler (152) prior to the training of the graph neural network model (162) and the feed-forward neural network (168) of FIG. 1. The graph neural network static profiler (228) generates predictions of branch frequencies and execution probabilities. The graph neural network static profiler (228) may utilize control flow graphs and intermediate representations extracted from the training source code (205) to make predictions.

The training block vectors (230) include feature representations of blocks extracted from the training source code (205). The training block vectors (230) may encode characteristics like node types, estimated computational cost, and control flow position. The training block vectors (230) may be input to the graph neural network model (232).

The graph neural network model (232) includes neural network layers that process graph-structured data. The graph neural network model (232) aggregates information between neighboring blocks in control flow graphs to generate informative feature representations. The graph neural network model (232) may output the training graph vectors (235).

The training graph vectors (235) include encoded feature representations output by the graph neural network model (232). The training graph vectors (235) capture information about individual blocks as well as their roles within the overall control flow graph structure. The training graph vectors (235) may be inputs to the feed-forward neural network (238) for branch-frequency prediction.

The feed-forward neural network (238) processes the training graph vectors (235) to generate the training branch-frequency predictions (240). The feed-forward neural network (238) may take multiple graph vectors as input corresponding to an if block and its true and false branches.

The training branch-frequency predictions (240) include the output predictions generated by the feed-forward neural network (238). The training branch-frequency predictions (240) estimate execution probabilities for branches in the training source code (205).

The dynamic profiler (252) compiles and executes the training source code (205) with representative inputs to collect runtime information. The dynamic profiler (252) may track execution counts for branches at if nodes. The dynamic profiler (252) may generate labels (e.g., the branch frequency labels (255)) for supervised training of the graph neural network model (232) and feed-forward neural network (238).

The branch frequency labels (255) include execution probabilities for branches derived from the dynamic profiler (252). The branch frequency labels (255) represent the true branch frequencies observed when running the training source code (205). The branch frequency labels (255) may be used as target values for supervised learning of the graph neural network model (232) and feed-forward neural network (238).

The loss function (268) compares the training branch-frequency predictions (240) to the branch frequency labels (255) to quantify prediction errors. The loss function (268) may use weighted binary cross-entropy. The loss function (268) may generate gradients to update model parameters and improve prediction accuracy.

The training updates (280) include parameter adjustments for the graph neural network model (232) and feed-forward neural network (238) based on errors between the training branch-frequency predictions (240) and the branch frequency labels (255). The training updates (280) may modify weights of the models to reduce the loss calculated by the loss function (268) in subsequent iterations. The training updates (280) may be applied iteratively to optimize the models for accurate branch-frequency predictions.

FIG. 3 shows a flowchart of a method of static profiling with graph neural networks. The method of FIG. 3 may be implemented using the system of FIG. 1 and FIG. 2, and one or more of the steps may be performed on, or received at, one or more computer processors. The system may include at least one processor and an application that, when executing on the at least one processor, performs the method. A non-transitory computer readable medium may include instructions that, when executed by one or more processors, perform the method. The outputs from various components (including models, functions, procedures, programs, processors, etc.) for performing the method may be generated by applying a transformation to inputs using the components to create the outputs without using mental processes or human activities.

Turning to FIG. 3, the process (300) may perform static profiling with graph neural networks. The process (300) may include multiple steps (e.g., steps (302) through (310)) that may execute on the components described in the other figures, including those of FIG. 1 and FIG. 2.

Step (302) includes executing a block model with a control flow graph to generate a block vector corresponding to a block of the control flow graph of source code. The block model may be executed by processing each block of the control flow graph to extract relevant features. The features extracted from a block may be combined to form the block vector representing characteristics of that block. The block vector may encode information about the structure and content of the corresponding block in a format suitable for further analysis.

Executing the block model further may include executing the block model with an intermediate representation and the control flow graph. The control flow graph may be generated with the intermediate representation. The intermediate representation may provide additional semantic information about the program structure beyond what is captured in the control flow graph alone. By incorporating both the intermediate representation and control flow graph, the block model may leverage complementary information sources to generate more informative block vectors.

Executing the block model further may include determining the block corresponds to conditional branching logic from the source code. Blocks containing conditional branching logic (e.g., an if statement) may be identified based on analysis of the control flow graph structure and intermediate representation. The presence of conditional branching logic may be determined by examining the node types and control flow edges associated with a given block.

Executing the block model may include generating the block of the control flow graph from multiple nodes from an intermediate representation. The intermediate representation may represent the source code. The intermediate representation nodes corresponding to a block in the control flow graph may be grouped together to form grouped nodes. The semantic information from the grouped nodes may be aggregated to characterize the block.

Executing the block model may include generating multiple block features for the block from one or more of the control flow graph and the intermediate representation. The block features may include one or more of a node type feature, a code characteristic estimation feature, and a control flow characteristic feature. Node type features may capture the kinds of operations present in the block. Code characteristic estimation features may represent metrics like estimated computational cost. Control flow characteristic features may encode a position and role of a block within the control flow structure.

Executing the block model may include aggregating the multiple block features to form the block vector. The individual features extracted for a block may be combined into a single vector representation. The aggregation may involve concatenation, weighted combination, or other techniques to merge the diverse feature types into a unified block vector.

Step (305) includes executing a graph neural network model with the control flow graph and the block vector to generate a graph vector. The graph neural network model may process the structural information encoded in the control flow graph along with the features captured in the block vector. The resulting graph vector may encode both local block characteristics and broader contextual information from the surrounding control flow structure. The graph neural network model may use a sample and aggregate algorithm (e.g., graph sample and aggregate (GraphSAGE)) to generate node embeddings by iteratively aggregating information from a local neighborhood of a node. The iterations may utilize multiple layers with one iteration for one layer in which each layer may sample and aggregate information.

In the sampling step, a number of neighbors may be selected for each node in the control graph. The selection may be random or based on specific strategies like importance sampling. The sampling process may be performed layer-wise, with the number of sampled neighbors increasing when moving deeper into the graph neural network model to capture information from progressively larger neighborhoods.

In the aggregation step, the features of the sampled neighbors are combined using a differentiable aggregation function. The function may use averaging, summation, long short-term memory (LSTM) models, attention models, etc. The aggregated features are then combined with the features of the current node (i.e., the block vector) using a learned weight matrix and a non-linear activation function. The updated feature representation becomes the embedding for the current layer of the multiple layers of iteration. The final layer embedding is the graph vector (having the same dimensions as the original block vector) that represents the block of the control flow graph. The graph vectors are different from the block vectors in that the block vectors may include information that is deterministically extracted from the control flow graph (types of nodes, execution estimates, control flow characteristics, etc.) and the graph vectors are weighted aggregations of selected (i.e., sampled) block vectors.

The control flow graph may be a caller control flow graph and executing the graph neural network model may include inlining a callee control flow graph into the caller control flow graph. When processing a method invocation, the callee control flow graph may be integrated into the caller control flow graph at the invocation point. Edges may be added to connect the entry and exit points of the callee control flow graph to the appropriate blocks in the caller control flow graph. The combined graph may provide information about the integrated control flow across method boundaries to improve prediction accuracy.

Step (308) includes executing a feed-forward neural network with the graph vector to generate a branch-frequency prediction. The feed-forward neural network may include multiple fully connected layers that process the graph vector. Non-linear activation functions may be applied between layers to capture complex relationships in the data. The final layer may utilize a sigmoid activation function and output a probability value representing the predicted frequency of taking a particular branch.

Executing the feed-forward neural network may include executing the feed-forward neural network with multiple graph vectors comprising the graph vector, a true branch graph vector, and a false branch graph vector. For conditional statements, graph vectors may be generated for the block containing the condition as well as the blocks corresponding to the true and false branches. Providing vectors for relevant blocks includes characteristics of both potential execution paths, which may improve prediction accuracy.

Step (310) includes incorporating the branch-frequency prediction into a code profile. The predicted branch frequencies may be associated with the corresponding locations in the control flow graph or intermediate representation. The resulting code profile may capture the expected dynamic behavior of the program based on static analysis. The profile may be used to guide subsequent optimization decisions during compilation.

Incorporating the branch-frequency prediction may include incorporating a loop guard value instead of the branch-frequency prediction when the branch-frequency prediction satisfies a loop guard definition. For branches leading into loop bodies, a minimum probability may be assigned to prevent loops from being de-emphasized. When the predicted frequency satisfies the loop guard definition (e.g., by falling below a threshold), the loop guard value may be used instead of the branch-frequency prediction to avoid underestimating loop execution likelihood. The loop guard value and the threshold of the loop guard definition may be the same number.

Incorporating the branch-frequency prediction includes incorporating an exit guard value instead of the branch-frequency prediction when the branch-frequency prediction satisfies an exit guard definition. For branches leading to program termination, an upper bound may be placed on the predicted frequency. When the prediction satisfies the exit guard definition (e.g., by exceeding a threshold), the exit guard value may be used instead of the branch-frequency prediction to avoid overemphasizing paths that lead to early termination. The exit guard value and the threshold of the exit guard definition may be the same number.

The process (300) may further include executing one or more of a parsing phase modifier and an inlining phase modifier with the code profile to generate modified code. The parsing phase modifier may analyze the code profile during a parsing phase of compilation. Branch-frequency predictions from the code profile may be used for optimization decisions, which may include code reordering or loop transformations. The inlining phase modifier may utilize the code profile during method inlining to determine methods to be inlined and in what order. Frequent execution paths (e.g., that have branch prediction frequencies above a threshold amount) that are identified in the profile may be prioritized for inlining to improve runtime performance. The modified code generated with the optimizations from the parsing phase modifier and the inlining phase modifier may have improved execution speed or reduced memory usage compared to unoptimized code.

The process (300) may further include executing the modified code. The modified code may be stored on a memory and executed on a processor. The modified code and the execution of the modified code may result in improvements due to reduced memory usage, reduced runtime, combinations thereof, etc., as compared to executing the source code without making the modifications present in the modified code.

The process (300) may further include training one or more of the graph neural network model and the feed-forward neural network. Training may involve an iterative process of providing input examples, comparing model outputs to known labels, and adjusting model parameters to improve accuracy. A dataset of training programs with known runtime behavior may be used. The block model may be trained to extract relevant features from individual blocks. The graph neural network model may be trained to aggregate information across the control flow graph structure. Training may continue until a desired level of prediction accuracy is achieved on a validation dataset.

Training one or more of the block model and the graph neural network model may include executing a dynamic profiler to generate a branch frequency label. The dynamic profiler may compile and execute training programs with representative inputs. During execution, the profiler may track the number of times each branch is taken. Branch frequency labels may be computed as a ratio of the number times a branch was taken to the total number of times the corresponding conditional statement was executed. The labels represent the true branch frequencies observed during actual program execution and may be used as target values for supervised learning of the models.

Training one or more of the block model and the graph neural network model may include executing a loss function with a training branch-frequency prediction and the branch frequency label to generate a training update. The loss function may quantify the difference between predicted branch frequencies and observed frequencies from the dynamic profiler. A weighted binary cross-entropy loss may be used with weights based on execution counts to prioritize accurate prediction of frequently executed branches. The loss function may generate gradients identifying adjustments to model parameters to reduce prediction errors. The gradients may be used to generate training updates for the models.

Training one or more of the graph neural network model and the feed-forward neural network may include updating the one or more of the graph neural network model and the feed-forward neural network using the training update. The training update may include parameter adjustments for the layers in the graph neural network model and the feed-forward neural network. An optimization algorithm like stochastic gradient descent or Adam may be applied to update model weights based on the computed gradients. The learning rate and other hyperparameters of the optimization process may be tuned to balance training speed and stability. Updates may be applied in batches to improve training efficiency. The model update process may be repeated over multiple epochs until convergence or a maximum number of iterations is reached.

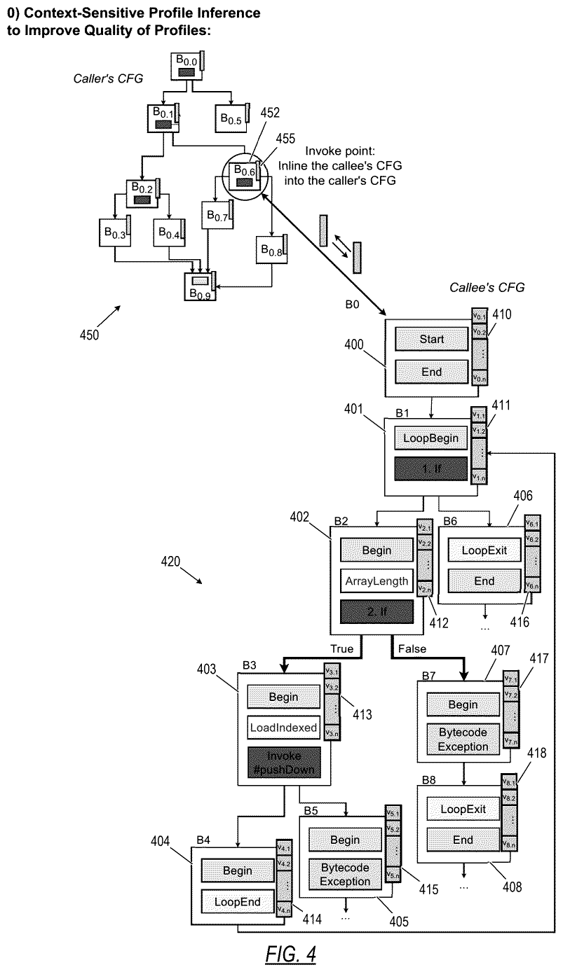

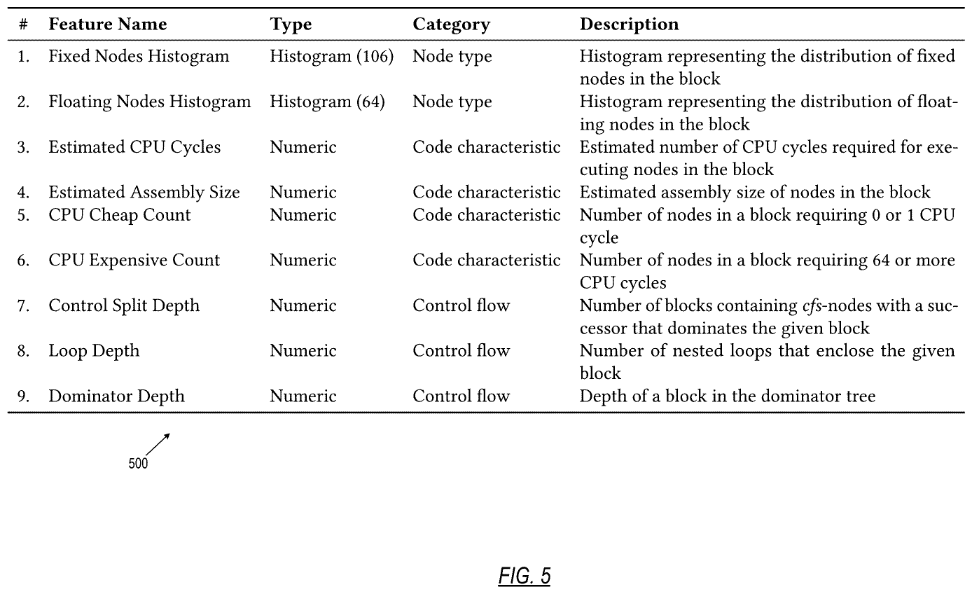

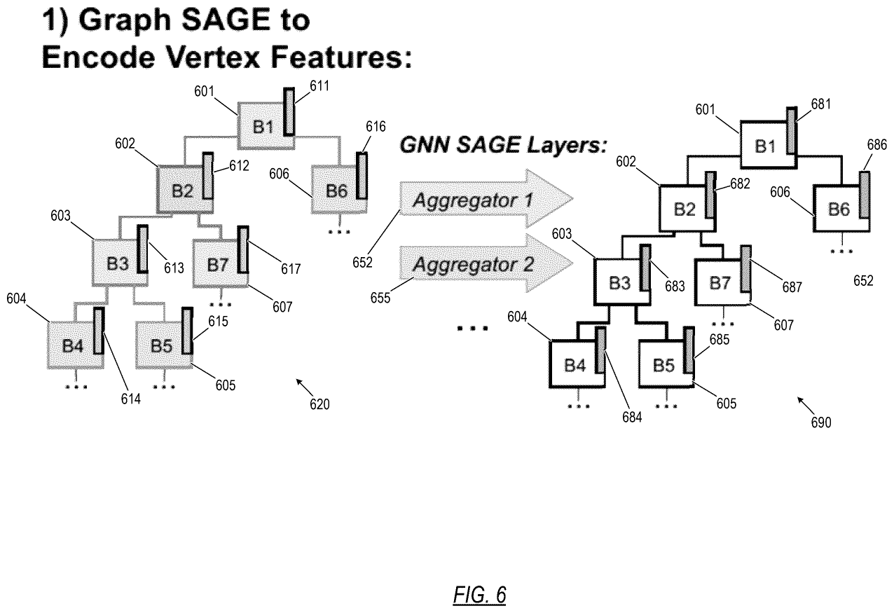

FIG. 4 through FIG. 7 show examples of an embodiment of the disclosure and steps that may be performed by a static profiler to predict dynamic profiles. FIG. 4 depicts generating graphs. FIG. 5 depicts a table of features used for block vectors. FIG. 6 depicts using a graph neural network model. FIG. 7 depicts using a feed-forward model.

Turning to FIG. 4, the control flow graph (420) may be used to generate code profiles with branch-frequency predictions without executing the source code from which the control flow graph (420) is generated. The control flow graph (420) includes the blocks B0 (400), B1 (401), B2 (402), B3 (403), B4 (404), B5 (405), B6 (406), B7 (407), and B8 (408). Each of the blocks B0 (400) through B8 (408) represent a number of instructions (e.g., “Start”, “End”, “LoopBegin”, etc.). The block vectors (410), (411), (412), (413), (414), (415), (416), (417), and (418) are generated respectively for the blocks B0 (400), B1 (401), B2 (402), B3 (403), B4 (404), B5 (405), B6 (406), B7 (407), and B8 (408). The block vectors (410) through (418) each include a number of features describing characteristics of the blocks B0 (400) through B8 (408).

The block B2 (402) includes an If statement, includes a true branch leading to the block B3 (403), and includes a false branch leading to the block B7 (407). The block B2 (402) is a child of the block B1 (401).

The control flow graph (420) may be a callee control flow graph that may be incorporated into the callee control flow graph (450). The callee control flow graph (450) includes several blocks, including the block (452) with the block vector (455). The block (452) is the invocation point for the callee control flow graph (420).

The control flow graph (420) is a minimal structure that retains the control flow of the source code from which the control flow graph (420) was generated. Using the control flow graph reduces the computational overhead associated with graph processing for faster training and inference times. Additionally, the control flow graph (420) provides a clean representation of control flow to enhance the ability to learn effectively and achieve faster convergence.

Turning to FIG. 5, the table (500) provides examples of features that may be included in block vectors. Each block of a control flow graph may be represented as a vector of features. The features may be categorized into three groups based on the characteristics of the CFG blocks they describe.

Features may be related to node types. The internal structure of each block of a control flow graph may be captured using histograms of fixed and floating nodes (rows 1 and 2 of the table (500)). The histograms count the occurrences of each node type within a block. For example, a histogram for the fixed nodes in block B1 from FIG. 1 would show one If node and one LoopBegin node. Fixed nodes are nodes of an intermediate representation that execute in a fixed order whereas floating nodes may be executed in a different order from that provided by the initial intermediate representation and control flow graph generated from the source code.

Features may be related to code characteristic estimation. Low-level code characteristics may be estimated, which may provide a high-level statistical measure of a computational cost for a block. Specifically, the number of CPU cycles used for executing a block and its corresponding assembly size may be estimated (see rows 3 and 4 in the table (500)). The CPU cycle and assembly size features may be computed by summing the estimated CPU cycles and assembly size for each fixed and floating nodes within a block. To further refine the features, nodes from the block are categorized based on CPU cycle counts: nodes requiring 0 or 1 CPU cycle may be labeled “CPU Cheap”, while nodes requiring 64 or more cycles may be labeled “CPU Expensive”. Counts of the node types are provided within each block (rows 5 and 6 in the table (500)).

Features may be related to control flow characteristics. Features such as control split depth, loop depth, and dominator depth (rows 7-9 in the table (500)) characterize the control flow position of a block within a control flow graph. Dominator depth measures the number of nodes in a control flow graph that are traversed to reach a particular node from the entry node.

Once the features of a block of a control flow graph are collected, the features are represented in a vector form (e.g. the block vector (413) for the block (403) of FIG. 4). Since the features of rows 1 and 2 of the table (500) are categorical (in the form of histograms), one-hot encoding is used to convert the features into fixed-size vectors. Each unique fixed and floating node type is given a position in the vertex feature vector, indicating the count of that node type in the corresponding block. As an example, there may be 106 fixed node types and 64 floating node types to yield a block vector length of 177 (106 (for row 1)+64 (for row 2)+7 (for rows 3 through 9)).

Additionally, numerical features may be normalized based on mean and standard deviation, calculated from the training data, for stable and efficient model training. For example, each numerical feature x may be transformed using x=(x−μₓ)/σₓ, where μₓ and σₓ are the mean and standard deviation of x in the training data.

An edge matrix may also be generated and input to the graph neural network model. To encode the structure of the graph for the graph neural network model, an edge matrix may be used that represents the connections between graph vertices. The edge matrix, edgeMatrix, may be structured as a 2-by-M matrix of block IDs, with M being the number of edges in the graph. Each column i of the matrix specifies a directed edge from block edgeMatrix[0][i] to block edgeMatrix[1][i]. For example, the edgeMatrix for the displayed edges of the callee's CFG in FIG. 1 would be:

$$edgeMatrix = [ \begin{matrix}B 0 & B 1 & B 1 & B 2 & B 2 & B 3 & B 3 & B 4 & B 7 \\ B 1 & B 2 & B 6 & B 3 & B 7 & B 4 & B 5 & B 1 & B 8\end{matrix} ]$$

The edge matrix above shows connections in one direction. In practice, an edge matrix may include connections in both directions for each pair of neighboring blocks in a control flow graph.

Turning to FIG. 6, a graph neural network model (also referred to as a graph neural network (GNN)) generates the graph vectors (681) through (687) from the block vectors (611) through (617) using the control flow graph (620). The graph neural network model includes the first aggregator layer (652) and the second aggregator layer (655). The first aggregator layer (652) aggregates one level to include immediate neighbors (e.g., blocks (601), (603), and (607) are immediate neighbors of the block (602)). The second aggregator layer (655) aggregates two levels to include immediate neighbors and the immediate neighbors of immediate neighbors (e.g., in addition to blocks (601), (603), and (607), the blocks (604), (605), and (606) are also included).

Given a control flow graph as [symbol] ( [symbol] , [symbol] ), which is defined as a graph [symbol] with a set of control flow graph (CFG) blocks [symbol] and edges [symbol] , input vectors for the graph neural network model are extracted. Specifically, block vectors, which may each have a length of 177, are derived to form a feature matrix X∈ [symbol] , where each row represents a feature vector of a block of a control flow graph (also referred to as a graph vertex). Additionally, an edge matrix E∈ [symbol] is constructed from the edge set [symbol] , representing the connections between blocks of the control flow graph.

The graph neural network model uses layers defined as composition of a graph convolutional layer (e.g., SAGEConv) and graph neural network normalization (GraphNorm) such that fᵢₙ, f_{hid}=GraphNorm. SAGEConv. The layers are defined as functions of:

$${f}_{in} : ( {\vert ℬ \vert \times 177}^{} , {2 \times \vert ℰ \vert}^{} ) ↦ {\vert ℬ \vert \times D}^{} , \qquad Eq . 1$$

$${f}_{hid} : ( {\vert ℬ \vert \times 𝒟}^{} , {2 \times \vert ℰ \vert}^{} ) ↦ {\vert ℬ \vert \times D}^{} , \qquad Eq . 2$$

where D is the hidden size of the graph neural network model.

Graph convolutional layers provide for inductive node representation learning that generalizes to unseen nodes. Graph convolutional layers may learn a function that generates embeddings by sampling and aggregating features from a local neighborhood of a node, which makes the technique expressive and computationally efficient for large-scale graphs. Graph convolutional layers may be lightweight and expressive to capture complex graph structures while maintaining scalability. Additionally, graph convolutional layers may have robustness to unseen and rarely encountered nodes, which makes graph convolutional layers suited for control flow graph blocks that may contain nodes that appear infrequently in the program or even nodes that were not present in the training data. The robustness supports reliable performance even when encountering infrequent graph structures.

Graph normalization (GraphNorm) is applied to stabilize the training process and improve model performance. Graph normalization normalizes the features of nodes in a graph, which may yield convergence with fewer resources and better generalization, especially in deeper graph networks.

The extracted input vectors from the control flow graph, X∈ [symbol] and E∈ [symbol] , are passed through N (where N is at least 2) graph neural network layers (e.g., the first aggregator layer (652) and the second aggregator layer (655)) of the graph neural network model, alternating with the activation function φ, where φ=Gaussian error linear unit (GELU) selected as the activation function. GELU may be selected to provide smoother activation outputs compared to outputs from a rectified linear unit (ReLU), which improves performance across various tasks. The model is formulated as:

$${X}^{( N )} = {f}_{hid} ∘ {\underbrace{ϕ ( {f}_{hid} ) ∘ … ∘ ϕ ( {f}_{hid} )}}_{( N - 2 ) - times} ∘ ϕ ( {f}_{in} ( X , E ) ) \qquad Eq . 3$$

where X^{(N)}=∈ [symbol] represents the encoded feature representation of the control flow graph blocks. The features, after processing by the graph neural network model, describe the block itself and also capture the role and position of the block within the control flow graph.

Turning to FIG. 7, the feed-forward model (720) processes the graph vectors (782), (783), and (787) to generate the branch frequency probability (p_{True}) (732). The graph vectors (782), (783), and (787) may be processed with multiple layers, including the intermediate layers (725) and the last layer (728). The intermediate layers may use rectified linear unit (ReLU) activation, Gaussian error linear unit (GELU) activation, etc. The last layer may use the sigmoid activation (730).

To illustrate the inference process, consider the block B2 (402) of FIG. 4 (which corresponds to the block B2 (602) of FIG. 6) that ends with an If node and has two branches leading to the blocks B3 (403) and B7 (407) of FIG. 4, where edge B2-B3 represents the True branch. To predict the True branch execution probability, the encoded features of blocks B2, B3, and B7, i.e.,

$${X}_{B 2}^{( N )} , {X}_{B 3}^{( N )} , {X}_{B 7}^{( N )} ∈ {D}^{}$$

are used. These features are concatenated and passed through the feedforward model (720) (which may be a feed-forward neural network (FNN)). The probability of the True branch (for the block B3 (403) of FIG. 4) is then computed using the sigmoid function (730), defined as

$$σ ( x ) = \frac{1}{1 + exp ( - x )} ,$$

over the output of the feed-forward model (720) as:

$${p}_{B 1 , True} = σ ( FNN [ {X}_{B 2}^{( N )} , {X}_{B 3}^{( N )} , {X}_{B 7}^{( N )} ] ) \qquad Eq . 4$$

The probability of the False branch (for the block B7 (407) of FIG. 4) is then calculated as p_{B1,False}=1−p_{B1,True}. The process may repeat for blocks of the control flow graph that include if statements to infer branching probabilities across the entire control flow graph.

Context-sensitive profile inference may be included. To predict context-sensitive profiles, instead of extracting features from the control flow graph of the method where branch probabilities are to be inferred, additional contextual features from the caller control flow graph may be used if the specific call chain is available. Specifically, the block containing an invoke node in the caller graph, which represents the call point of the method whose profiles are to be predicted, is substituted with the control flow graph of that method. By inlining the callee control flow graph into the caller control flow graph, a context-sensitive control flow graph that incorporates both the method and the calling context is created. Features extracted from the context-sensitive control flow graph are then passed to the graph neural network model to make predictions of branch probabilities.

For instance, given the caller control flow graph [symbol] ( [symbol] , [symbol] ) and the callee control flow graph [symbol] ( [symbol] , [symbol] ), invoked in the control flow graph block denoted as bᵢₙᵥₒₖₑ ∈ [symbol] , bᵢₙᵥₒₖₑ in [symbol] is replaced with the entire graph [symbol] to create a new context-sensitive graph [symbol] ( [symbol] , [symbol] ). In the new graph, the set of blocks is [symbol] =( [symbol] ∪ [symbol] )\{b_{Invoke}}, and the set of edges is [symbol] =( [symbol] \{(bₚₐᵣₑₙₜ, b_{Invoke}), (b_{Invoke}, b_{child})})∪ [symbol] ∪{(bₚₐᵣₑₙₜ, b_{entry}) (bₑₓᵢₜ, b_{child})}, where b_{entry} and bₑₓᵢₜ are the entry and exit blocks of [symbol] . The edges that previously connected bᵢₙᵥₒₖₑ to the parent block bₚₐᵣₑₙₜ and child block b_{child} of b_{Invoke} are redirected to instead connect bₚₐᵣₑₙₜ to the entry block b_{entry} Of [symbol] and the exit block bₑₓᵢₜ of [symbol] to b_{child}².

Although the call chain includes multiple methods, the context is the immediate caller control flow graph instead of a larger graph. Using the caller control flow graph, which may be with a call chain depth of 1, may reduce computational overhead in the graph neural network model, as smaller graphs are given on average, improving the compile time.

Branch-probability prediction heuristics may also be included. To enhance the reliability of the model, branch probability heuristics may be incorporated to refine predicted profiles for both context-insensitive and context-sensitive cases. The heuristics prevent degradation in program execution speed, even when the predicted profiles are inaccurate due to the presence of outliers.

The loop heuristic and the dead-end heuristic may reduce risks associated with deploying static profiling frameworks in compilers while enhancing program runtime performance. The loop heuristic may assign a minimum probability, referred to as the loop guard (LG), to branches that lead into loop bodies, prioritizing paths in execution predictions. The method helps compilers recognize loops, which may be executed multiple times.

The dead-end heuristic caps probabilities of branches leading to program termination, known as the exit guard (EG), to prevent overestimating paths. Specifically, the heuristic limits probability of terminating branches when non-terminating branches have significant assembly sizes, using two thresholds: maximum exit probability and minimum non-terminal branch assembly size, where the first is conditioned upon the second. The approach prevents compilers from overlooking optimization opportunities in non-terminating branches, preventing GraalNN from favoring paths leading to early termination.

By refining predicted probabilities through heuristics, the model may improve robustness and effectiveness in profile-guided optimizations. The approach balances accuracy and practical usability, minimizing chances of generating suboptimal code due to outlier predictions. Moreover, the approach prevents compilers from making aggressive optimizations based on inaccurate predictions, which could result in performance penalties in compiled programs.

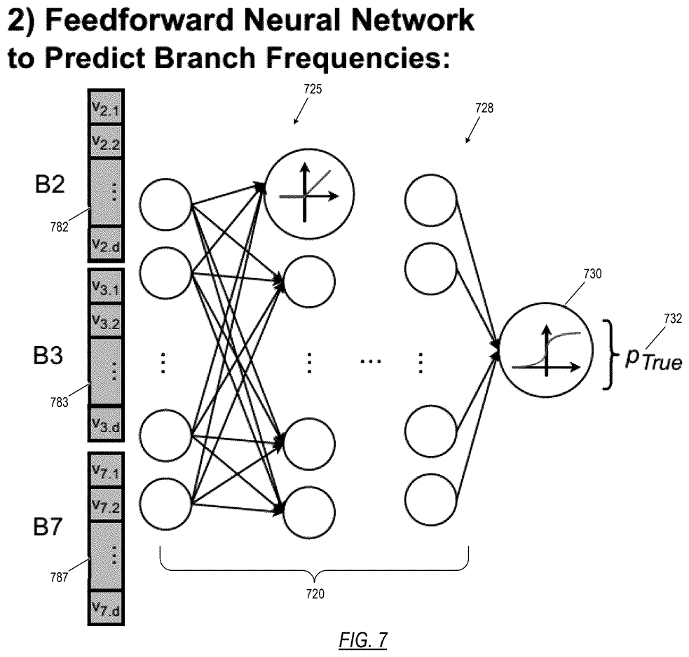

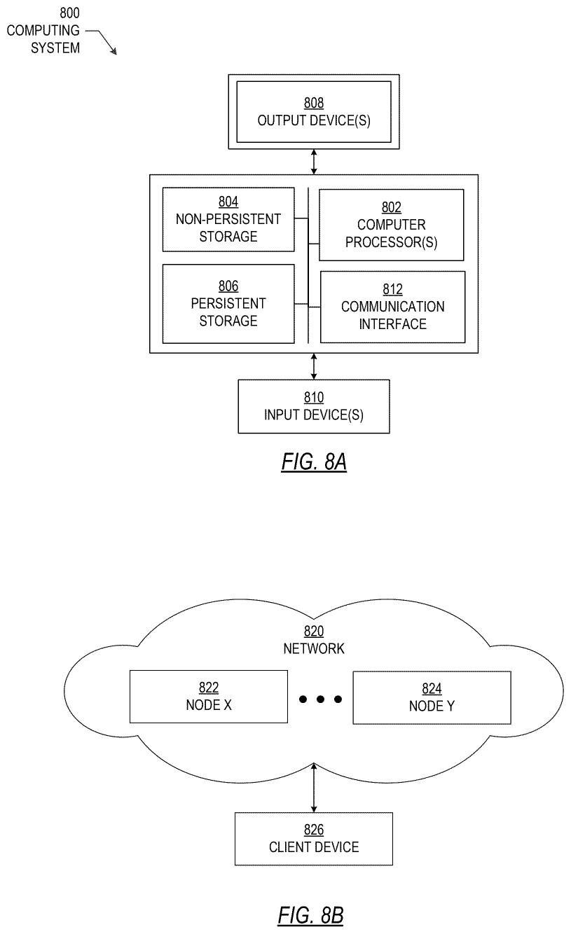

Embodiments may be implemented on a special purpose computing system specifically designed to achieve the improved technological result. Turning to FIGS. 8A and 8B, the special purpose computing system (800) may include one or more computer processors (802), non-persistent storage (804), persistent storage (806), a communication interface (812) (e.g., Bluetooth interface, infrared interface, network interface, optical interface, etc.), and numerous other elements and functionalities that implement the features and elements of the disclosure. The computer processor(s) (802) may be an integrated circuit for processing instructions. The computer processor(s) may be one or more cores or micro-cores of a processor. The computer processor(s) (802) includes one or more processors. The one or more processors may include a central processing unit (CPU), a graphics processing unit (GPU), a tensor processing unit (TPU), combinations thereof, etc.

The input device(s) (810) may include a touchscreen, keyboard, mouse, microphone, touchpad, electronic pen, or any other type of input device. The input device(s) (810) may receive inputs from a user that are responsive to data and messages presented by the output device(s) (808). The inputs may include text input, audio input, video input, etc., which may be processed and transmitted by the computing system (800) in accordance with the disclosure. The communication interface (812) may include an integrated circuit for connecting the computing system (800) to a network (not shown) (e.g., a local area network (LAN), a wide area network (WAN) such as the Internet, mobile network, or any other type of network), and/or to another device, such as another computing device.

Further, the output device(s) (808) may include a display device, a printer, external storage, or any other output device. One or more of the output device(s) (808) may be the same or different from the input device(s) (810). The input device(s) (810) and the output device(s) (808) may be locally or remotely connected to the computer processor(s) (802). Many different types of computing systems exist, and the aforementioned input device(s) (810) and output device(s) (808) may take other forms. The output device(s) (808) may display data and messages that are transmitted and received by the computing system (800). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that, when executed by a processor(s), is configured to perform one or more embodiments, which may include transmitting, receiving, presenting, and displaying data and messages described in the other figures of the disclosure.

The computing system (800) in FIG. 8A may be connected to or be a part of a network. For example, as shown in FIG. 8B, the network (820) may include multiple nodes (e.g., node X (822) and node Y (824)). Each node may correspond to a computing system, such as the computing system (800) shown in FIG. 8A, or a group of nodes combined may correspond to the computing system (800) shown in FIG. 8A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (800) may be located at a remote location and connected to the other elements over a network.

The nodes (e.g., node X (822) and node Y (824)) in the network (820) may be configured to provide services for a client device (826), including receiving requests and transmitting responses to the client device (826). For example, the nodes may be part of a cloud computing system. The client device (826) may be a computing system, such as the computing system (800) shown in FIG. 8A. Further, the client device (826) may include and/or perform all or a portion of one or more embodiments of the disclosure.

The computing system (800) of FIG. 8A may include functionality to present raw and/or processed data, such as results of comparisons and other processing. For example, presenting data may be accomplished through various presenting methods. Specifically, data may be presented by being displayed in a user interface, transmitted to a different computing system, and stored. The user interface may include a GUI that displays information on a display device. The GUI may include various GUI widgets that organize what data is shown as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be temporary, permanent, or semi-permanent communication channel between two entities.

The various descriptions of the figures may be combined and may include or be included within the features described in the other figures of the application. The various elements, systems, components, and steps shown in the figures may be omitted, repeated, combined, and/or altered as shown from the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

Further, unless expressly stated otherwise, or is an “inclusive or” and, as such includes “and.” Further, items joined by an “or” may include any combination of the items with any number of each item unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above may be devised which do not depart from the scope of the claims as disclosed herein. Accordingly, the scope should be limited only by the attached claims.

What is claimed is:

1. A method comprising:
executing a block model with a control flow graph to generate a block vector corresponding to a block of the control flow graph of source code;
executing a graph neural network model with the control flow graph and the block vector to generate a graph vector;
executing a feed-forward neural network with the graph vector to generate a branch-frequency prediction; and
incorporating the branch-frequency prediction into a code profile.

2. The method of claim 1, wherein the control flow graph is a caller control flow graph and wherein executing the graph neural network model comprises:
inlining a callee control flow graph into the caller control flow graph.

3. The method of claim 1, further comprising:
executing one or more of a parsing phase modifier and an inlining phase modifier with the code profile to generate modified code; and
executing the modified code.

4. The method of claim 1, wherein executing the feed-forward neural network comprises:
executing the feed-forward neural network with a plurality of graph vectors comprising the graph vector, a true branch graph vector, and a false branch graph vector.

5. The method of claim 1, wherein executing the block model further comprises:
executing the block model with an intermediate representation and the control flow graph, wherein the control flow graph is generated with the intermediate representation.

6. The method of claim 1, wherein executing the block model further comprises:
determining the block corresponds to conditional branching logic from the source code.

7. The method of claim 1, wherein incorporating the branch-frequency prediction comprises:
incorporating a loop guard value instead of the branch-frequency prediction when the branch-frequency prediction satisfies a loop guard definition.

8. The method of claim 1, wherein incorporating the branch-frequency prediction comprises:
incorporating an exit guard value instead of the branch-frequency prediction when the branch-frequency prediction satisfies an exit guard definition.

9. The method of claim 1, further comprising:
training one or more of the graph neural network model and the feed-forward neural network by:
executing a dynamic profiler to generate a branch frequency label;
executing a loss function with a training branch-frequency prediction and the branch frequency label to generate a training update; and
updating the one or more of the graph neural network model and the feed-forward neural network using the training update.

10. The method of claim 1, wherein executing the block model comprises:
generating the block of the control flow graph from multiple nodes from an intermediate representation, wherein the intermediate representation represents the source code;
generating multiple block features for the block from one or more of the control flow graph and the intermediate representation, wherein the block features comprise one or more of a node type feature, a code characteristic estimation feature, and a control flow characteristic feature; and
aggregating the multiple block features to form the block vector.

11. A system comprising:
at least one processor; and
an application that, when executing on the at least one processor, performs operations comprising:
executing a block model with a control flow graph to generate a block vector corresponding to a block of the control flow graph of source code,
executing a graph neural network model with the control flow graph and the block vector to generate a graph vector,
executing a feed-forward neural network with the graph vector to generate a branch-frequency prediction, and
incorporating the branch-frequency prediction into a code profile.

12. The system of claim 11, wherein the control flow graph is a caller control flow graph and wherein executing the graph neural network model comprises:
inlining a callee control flow graph into the caller control flow graph.

13. The system of claim 11, wherein the application further performs operations comprising:
executing one or more of a parsing phase modifier and an inlining phase modifier with the code profile to generate modified code; and
executing the modified code.

14. The system of claim 11, wherein executing the feed-forward neural network comprises:
executing the feed-forward neural network with a plurality of graph vectors comprising the graph vector, a true branch graph vector, and a false branch graph vector.

15. The system of claim 11, wherein executing the block model further comprises:
executing the block model with an intermediate representation and the control flow graph, wherein the control flow graph is generated with the intermediate representation.

16. The system of claim 11, wherein executing the block model further comprises:
determining the block corresponds to conditional branching logic from the source code.

17. The system of claim 11, wherein incorporating the branch-frequency prediction comprises:
incorporating a loop guard value instead of the branch-frequency prediction when the branch-frequency prediction satisfies a loop guard definition.

18. The system of claim 11, wherein incorporating the branch-frequency prediction comprises:
incorporating an exit guard value instead of the branch-frequency prediction when the branch-frequency prediction satisfies an exit guard definition.

19. The system of claim 11, wherein the application further performs operations comprising:
training one or more of the graph neural network model and the feed-forward neural network by:
executing a dynamic profiler to generate a branch frequency label;
executing a loss function with a training branch-frequency prediction and the branch frequency label to generate a training update; and
updating the one or more of the graph neural network model and the feed-forward neural network using the training update.

20. A non-transitory computer readable medium comprising instructions executable by at least one processor to perform:
executing a block model with a control flow graph to generate a block vector corresponding to a block of the control flow graph of source code;
executing a graph neural network model with the control flow graph and the block vector to generate a graph vector;
executing a feed-forward neural network with the graph vector to generate a branch-frequency prediction; and
incorporating the branch-frequency prediction into a code profile.
